(19) United States
(12) Patent Application Publication
(10) Pub. No.: US 2017/0043365 A1
(43) Pub. Date: Feb. 16, 2017

(54) PORTABLE REFILLABLE CREAM DISPENSER

(71) Applicant: BEAUTY UNION GLOBAL LIMITED, HONG KONG (CN)

(72) Inventors: Yi Ming HUI, GUANGDONG (CN); Zhi WANG, GUANGDONG (CN)

(73) Assignee: BEAUTY UNION GLOBAL LIMITED, HONG KONG (CN)

(21) Appl. No.: 15/307,199

(22) PCT Filed: Apr. 30, 2015
(86) PCT No.: PCT/IB2015/053141

§ 371 Date: Oct. 27, 2016

(30) Foreign Application Priority Data
Apr. 30, 2014 (CN) 201420218192.9

(51) Int. Cl. B05B 11/00

(52) U.S. Cl. CPC B05B 11/0056; B05B 11/0016; B05B 11/0051; B05B 11/0089; B05B 11/3087

(57) ABSTRACT

A dispenser (100) comprises a bottle (110) having an external wall (111), a gasket (120) defining an upper cavity (112) and a lower cavity (114) within the bottle and configured to substantially seal said upper cavity (112) form said lower cavity (114), and a fluid dispensing mechanism configured to allow fluid to be dispensed from said lower cavity (114) to the outside of the bottle (110) when the dispensing mechanism is actuated, wherein said gasket (120) is capable of moving towards the lower cavity (114) upon actuation of the dispensing mechanism and of moving towards the upper cavity (112) upon entrance of the fluid into said lower cavity (114), and a fluid refill mechanism configured to allow fluid to enter said lower cavity (114) when said refill mechanism is fluidly coupled to a fluid source.

### FIELD OF THE INVENTION

The present invention relates to small and easily portable and refillable dispensers of liquids such as creams.

### BACKGROUND OF THE INVENTION

Commercially available cream dispensing bottles are not reusable; moreover, they are usually made of hard and thick plastic to endure mechanical abuse such as accidental drops, and are thus a serious environmental liability.

WO2005/101969 describes a refill bottle adapted to repeatedly receive and dispense liquid such as perfume. The refill bottle comprises a bottle having a bottom portion and an upper portion, an opening provided in the upper portion wherein the opening is adapted to be covered, and a refill mechanism provided in the bottom portion. The liquid is received through the refill mechanism from a regular bottle preferably provided with a spraying mechanism and is dispensed through the opening.

The refill bottle described in WO2005/101969 is unsuitable for viscous materials such as pastes, creams and liquid soaps. For example, cream might accumulate in large amounts in areas of the dispenser interior that are inaccessible to dispensing means of the bottle.

U.S. Pat. No. 7,665,635 to Ramet et al. describes an assembly for packaging and dispensing liquid, that includes a receptacle for containing a supply of liquid, and a refillable unit arranged to be placed in a separable manner on the receptacle. The refillable unit includes a body and a piston that is movable relative to the body and that co-operates therewith to define a storage chamber of variable volume for containing the liquid. The storage chamber is put into fluid communication with the receptacle to be filled therefrom when the refillable unit is placed on the receptacle. The refillable unit also includes a pump arranged to take liquid from the receptacle when the refillable unit is placed thereon, and to take liquid from the storage chamber when the refillable unit is separate from the receptacle. The pump includes a pump chamber that is distinct from the storage chamber.

In the refillable unit of Ramet et al. the composition can only enter the storage chamber as a result of change in the position of the piston. During refill of the refillable unit, the movement of the refillable unit relative to the receptacle serves to cause a displacement of the refillable unit relative to the piston, the latter essentially remaining in place. The structure described by Ramet et al. is not equipped with a gasket that can move only as a result of entrance of the viscous composition into the storage chamber.

The structure thus requires grasping the refillable unit in one hand and the receptacle in another hand and pulling the refillable unit upwards. Such operation is counterintuitive and requires careful coupling of the refillable unit and the receptacle, and using considerable force with both hands. The considerable force might well be excessive and cause permanent damage, especially if the refillable unit is very small.

In addition, the receptacle is not a regular cream bottle which is with an essentially flat top through which a dispensing stem extends, from inside the receptacle to outside it—i.e. the receptacle of Ramet et al. needs to be specially made with a fastener portion to allow it to clasp the gasket and hold it in place when the refillable unit is pulled away from the receptacle.

WO2013/014626 of Dongguan Yixin Magnetic Disc co. et al. describes a refillable dispenser for viscous compositions that includes:
a bottle having walls defining an upper cavity and a lower cavity;
a viscous composition refill mechanism configured to allow viscous composition to enter said upper cavity when said refill mechanism is fluidly coupled to a viscous composition source;
a viscous composition dispensing mechanism configured to allow viscous composition to be dispensed from said upper cavity to outside the bottle when the dispensing mechanism is actuated;
a gasket configured to substantially seal said upper cavity from said lower cavity, wherein:
   said gasket is capable of moving towards the upper cavity upon actuation of the dispensing mechanism, and
   moving towards the lower cavity upon entrance of the viscous composition into said upper cavity through said refill mechanism.

A potential problem with the dispenser is the dispensing mechanism. The mechanism typically juts into the upper cavity. Thus the upper cavity is restricted and there might be large dead volumes in the vicinity of the jutting mechanism, where large amounts of viscous fluid is trapped, that are both wasted and eventually spoil. To minimize the dead volumes the gasket may be specially designed to conform with the top part and of the upper cavity and with the jutting part of the dispensing mechanism; however such effective design is not easy to accomplish.

One object is to provide a simple and efficient cream bottle that is refillable; another object is to configure such bottle to allow refilling it in small amounts which are essentially dispensable from the bottle; another object is to configure the bottle so that the cream in the bottle can be essentially completely emptied out of the bottle by operating a dispensing mechanism.

Yet another object is to provide a kit that includes a regular (usually non-refillable) reservoir and a smaller and easily portable cream refill bottle that is easily refillable and compatible with the reservoir.

### SUMMARY OF THE INVENTION

In the claims, the word “comprise”, and variations thereof such as “comprises”, “comprising” and the like indicate that the components listed are included, but not generally to the exclusion of other components.

The term “cream” is to be broadly construed as a liquid for personal use such as cosmetic creams and lotions, colognes and perfumes, shampoos, conditioners, detergents, sera, jells etc.

According to one aspect, a dispenser is provided comprising:
a bottle having an external wall;
a gasket within the bottle; the gasket defining within the bottle an upper cavity and a lower cavity and configured to substantially seal said upper cavity from said lower cavity;
a fluid dispensing mechanism configured to allow fluid to be dispensed from said lower cavity to outside the bottle when the dispensing mechanism is actuated;
wherein said gasket is capable of moving towards the lower cavity upon actuation of the dispensing mechanism and of moving towards the upper cavity resultant upon entrance of the fluid into said lower cavity;
a fluid refill mechanism configured to allow fluid to enter said lower cavity when said refill mechanism is fluidly coupled to a fluid source.

In some embodiments the dispensing mechanism extends throughout the gasket to the lower cavity.

In some embodiments the dispensing mechanism comprises a tube extending into the lower cavity.

In some embodiments the lower cavity comprises a floor through which the fluid can enter the lower cavity, and the tube extends to less than 0.5 mm from the floor.

In some embodiments the tube extends to 0.2-0.3 mm from the floor.

In some embodiments the refill mechanism comprises a check-valve.

Some embodiments further comprise a refill chamber containing the refill mechanism, wherein the dispenser is configured to allow the refill chamber to be in fluid communication with the lower cavity, and allow the refill mechanism to remain essentially entirely inside the refill chamber, when the refill mechanism is actuated.

In some embodiments the upper cavity comprises a roof, and actuation of the dispensing mechanism allows the gasket to contact the roof.

In some embodiments the gasket is sealingly sleeved on the tube and in the bottle.

Some embodiments are characterized in that the refill mechanism has a seat that is movable and/or deformable between a stable state of sealed closure of the lower cavity and a stressed state of putting a non-refillable dispenser in communication with said lower cavity.

Some embodiments further comprise a vent hole that is arranged to compensate for dispensed fluid with air.

In some embodiments the vent hole extends from the upper cavity to outside the bottle.

In some embodiments the vent hole comprises a gap between the dispensing mechanism and the bottle.

According to another aspect a kit is provided comprising: any of the refillable dispensers described above and at least one adapter, the adapters each configured to allow sealingly and fluidly coupling a non-refillable dispenser with the refill mechanism of the refillable dispenser.

According to another aspect a kit is provided comprising: any of the refillable dispensers above a non-refillable dispenser for viscous compositions, the refillable dispenser and the non-refillable dispenser sealingly and fluidly connectable thereto.

The non-refillable dispenser may comprise a manual dispensation pump fluidly connectable to the refillable dispenser and wherein the refillable dispenser can be filled by repeatedly pressing the pump.

The non-refillable dispenser may comprise a manual dispensation pump fluidly connectable to the refillable dispenser and wherein the refillable dispenser can be filled by repeatedly pressing the pump.

In preferred embodiments the non-refillable dispenser is substantially larger than the refillable dispenser. The refillable dispenser is typically 3-20 mL and the non-refillable dispenser is typically at least 100 mL size.

### BRIEF DESCRIPTION OF THE FIGURES

In order to better understand the present invention and appreciate its practical applications the following figures are provided. Like components are denoted by like reference numerals. It should be noted that the figures are given as examples and preferred embodiments only and in no way limit the scope of the present invention as defined in the Detailed Description and Claims chapters.

FIG. 1 is a frontal sectional view of a refillable dispenser.

FIG. 2a is an the exploded view of the same dispenser;

A sectional view of the dispenser is shown in FIG. 2b;

FIG. 3 depicts another refillable dispenser with a compatible non-refillable dispenser;

FIG. 4 shows the refillable dispenser shown in FIG. 3, with another compatible non-refillable dispenser.

### DETAILED DESCRIPTION

The present invention provides a simple and compact refillable cream dispenser that can easily be refilled from a large non-refillable cream dispenser, typically simply by pressing the two dispensers together. The invention has advantages of simplicity of design and ability to be essentially completely emptied from cream, which can help prevent unwanted mixture of different creams, caking and spoiling of creams.

It is stressed that although the refillable dispenser has been tested and found to be useful for dispensation of liquids such as cosmetic creams and lotions, other liquids may be used such as perfumes. The refillable dispenser includes a dispensing mechanism that has a nozzle through which the liquid is dispensed. The nozzle is preferably replaceable, so that a user can select a suitable nozzle for the selected liquid, according to its viscosity as well as the size of the desired portions to be metered out. Other parts of the dispenser require no replacement to suit various liquids.

A refill mechanism allows the dispensers to be reused, and miniaturization of the dispensers also allows to do two important things: 1) to put the dispensers in pocket/purse/wallet etc for convenient use outside home due to small size, and 2) to take small samples of a first viscous composition (e.g. cream), and then take small samples of a second viscous composition, i.e. the user can easily vary the composition. However, the miniaturization also exacerbates waste of material since a relatively large amount of material remains stuck inside the container that might spoil, dry up and cake etc. Therefore, it is important to include in the dispenser a mechanism that allows thoroughly emptying viscous compositions out of the container. Surprisingly, although similar in a number of aspects to the refillable dispenser described in WO2013/014626, the present invention is more efficacious in exhaustion of the cream out of the dispenser if so desired, and is simpler to design and construct.

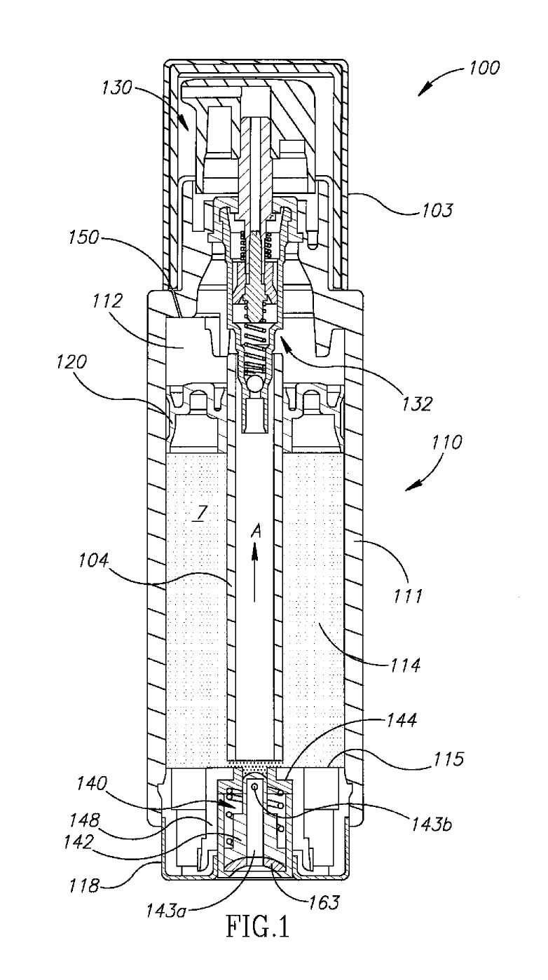

Thus, according to one aspect, a refillable dispenser for viscous compositions is provided that is intended to solve all these problems. Referring to FIG. 1, the dispenser 100 comprises:
a bottle 110 having an external wall 111;
a gasket 120 within the bottle 110;
the gasket 120 defining within the bottle 110 an upper cavity 112 and a lower cavity 114. The gasket 120 is configured to substantially seal said upper cavity 112 from said lower cavity 114;
a viscous composition dispensing mechanism 130 configured to allow viscous composition to be dispensed from said lower cavity 114 to outside the bottle 110 when the dispensing mechanism 130 is actuated;
wherein said gasket 120 is capable of moving towards the lower cavity 114 upon actuation of the dispensing mechanism 130 and of moving towards the upper cavity 112 solely upon entrance of the viscous composition into said lower cavity 114;
a viscous composition refill mechanism 140 configured to allow viscous composition to enter said lower cavity 114 when said refill mechanism 140 is fluidly coupled to a viscous composition source.

When the dispensing mechanism 130 is actuated, some viscous material 7 such as cream is ejected from the dispensing mechanism 130 to outside the bottle 111. In some embodiments, the material ejected from the dispensing mechanism 130 is replaced by more material drawn in by the dispensing mechanism 130 from the same actuation. As the material 7 is drawn out of the lower cavity 114, gasket 120 may go down, thus maintaining pressure in the lower cavity 114 and keeping the (smaller) cavity 114 full of cream.

A vent 150 is provided in the bottle, that allows air to enter the upper cavity 112, thus preventing creation of sub-pressure in upper cavity 112 during and following dispensation. When the refill mechanism 140 is actuated, the material 7 enters the lower cavity 114 and forces the gasket 120 upwards, i.e. the lower cavity 114 expands and the upper cavity 112 contracts, releasing air via the vent 150.

In the embodiment shown in FIG. 1 the vent is formed by a gap between the body 111 and the dispensing mechanism 130, as shown by an arrow indicating the passage of air through the vent 150.

In other embodiments (not shown) the vent is a hole in the external wall. Other embodiments have alternative exhaust/pressure maintenance means.

In some embodiments there is a vent (not shown) that allows exhaust of air introduced into the lower cavity inadvertently during the refill. However, it is stressed that such vent would preferably not include a tube leading from the lower cavity to outside the bottle, as this tube would get clogged by viscous materials such as cream.

The dispensing mechanism 130 may comprise a pump 132: when the pump 132 is actuated, e.g. in some embodiments pushed down, thus compressing the space inside the pump containing viscous material, the pump 132 pushes viscous material out. When the pump 132 is released, viscous material is drawn up from the lower cavity 114 into the pump 132.

In some embodiments, the pump is configured to not allow air into the upper cavity. In other embodiments, air is allowed into the upper cavity but is pumped out with actuation of the pump.

The dispenser 100 may be a foam dispenser: In embodiments having foam dispensers, the dispenser may comprise dual or more pumps, which when used move both air and the viscous composition through a small opening to create lather, e.g. shaving cream. In some embodiments, the air is introduced to the pump/s from outside the bottle 111.

In some embodiments, the dispenser is automatic, activated by a signal such as time-activation.

The dispenser 100 further comprises a cap 103 to cover the dispensing mechanism.

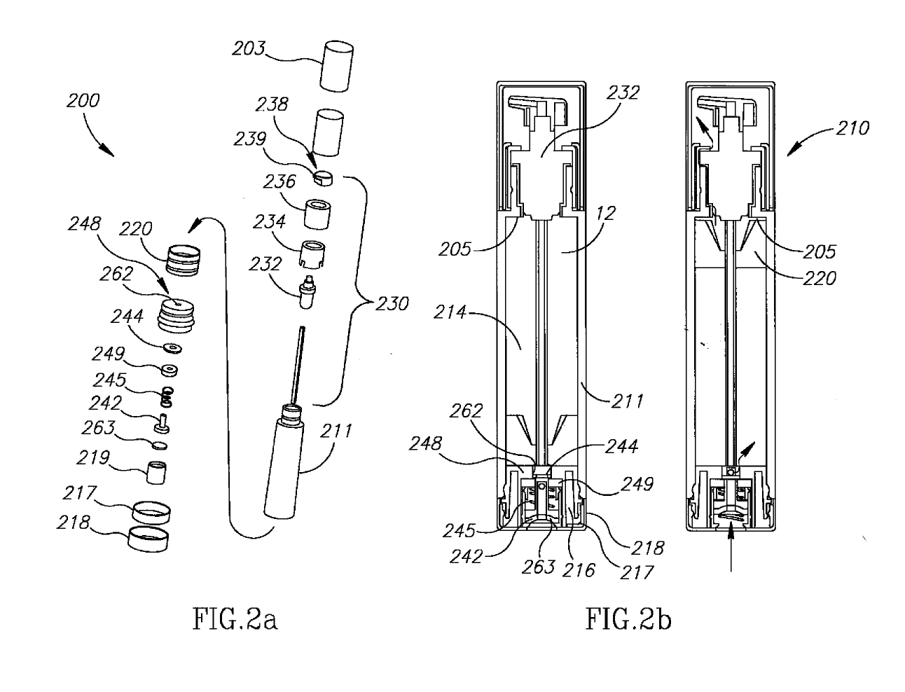

The dispensing mechanism 130 shown in FIGS. 1 and 2 is defined as including the tube 104. Thus, the dispensing mechanism 130 extends from outside the bottle 111 and throughout the upper cavity 112 and the gasket 120 into the lower cavity 114, so that the composition 7 can be conveniently provided from the bottom of the bottle 111. The gasket 120 is sealingly sleeved on the tube 104 and in the bottle 110. In some embodiments the tube may be proximal or flush with or even part of the wall, in which case the gasket may not be holed, yet it may nevertheless effectively seal the upper cavity from the lower cavity.

The refill mechanism 140 is situated inside a refill chamber 160 that is separated from the lower cavity 114 by a floor 115 in which there is a chamber hole 162 which allows fluid communication between the refill chamber 160 and the lower cavity 114. FIG. 1 depicts the dispenser 100 with the refill mechanism 140 at rest position, in which case the chamber hole 162 is blocked.

The refill mechanism 140 includes a hollow piston 142, with an entrance hole 143a and an exit hole 143b. Fluid such as cream may be introduced into the entrance hole 143a, which passes through the piston 142 to the exit hole 143b. A first seal ring 144 blocks exit hole 143b when the refill mechanism 140 is at rest. When the piston 142 is pushed the exit hole 143b is moved to a position in which the first seal ring 144 no longer blocks the exit hole and the fluid is free to exit chamber hole 162 into the lower cavity 114.

Note that in the depicted embodiment 100 the piston 142 may extend into the lower cavity 114 and into the tube 104 when extended. However, in other embodiments (not shown) the extension of the piston is limited by the chamber hole being much smaller, thereby preventing the piston from extending into the lower cavity. While a chamber hole might hinder flow of the fluid from the refill chamber into the lower cavity, extension of the piston 142 into the tube 104 might also hinder flow of the fluid into the lower cavity 114. While in other embodiments the tube could be made sufficiently thin to prevent such entrance of the piston into the tube, that setup might also hinder flow of fluid, particularly of viscous fluids such as cream. In other embodiments the tube is sufficiently shortened so that the piston does not reach the tube; however the fluid cannot be dispensed below the level of the tube, so that a considerable amount of fluid is left unused and might stagnate and spoil.

Therefore, as shown in FIG. 1, the tube 104 preferably extends to a very close distance to the floor 115, preferably 0.1-0.5 mm, more preferably 0.1-0.3 mm. In some embodiments (not shown) the refill mechanism is preferably sufficiently miniature so that even when fully extended the piston essentially remains wholly inside the refill chamber, and more preferably does not extend at all into the lower cavity. In such embodiments when the refill mechanism is employed the fluid first enters the refill chamber above the first sealing ring, then enters the lower cavity via the chamber hole. The miniaturization may help prevent the piston from being too close to the tube when extended.

Preferably, the tube extends to 0.1-0.3 mm from the floor 115, and the refill mechanism 140 is miniature. Such embodiments with bottles of 7-8 mL have been manufactured and found to work very well, and typically leave a residue of less than 500 μL after exhaustive dispensation.

Surprisingly, the dispenser of the present invention has been found to work well even when the tube is crooked, or not strictly parallel to the longitudinal axis A of the bottle, or aligned with the chamber hole, whereas when the dispenser described in WO2013/014626 is used the performance seems more dependent upon the tube being well aligned. It will occur that it is somewhat easier to introduce viscous liquid such as cream into the dispenser of the present invention, since the cream does not need to pass through the tube for this part of operation of the dispenser. This feature makes the dispenser easier to use and helps allow miniaturization of the refill mechanism, which in turn helps to allow the dispenser to be properly exhausted from material.

Another aspect is that the dispensing mechanism 130 should have a dispenser pump 132 that is short as possible, to allow maximum extension of the gasket 120 up toward the upper cavity 112, thereby also allowing maximum filling of the bottle 110 with the fluid. In fact, we have succeeded in making dispensers having dispensing pumps that extend less than 1 mm into the upper cavity.

Shown in an exploded view in FIG. 2a, and in sectional views in FIG. 2b (left view empty and right view full), another refillable dispenser 200 comprises a housing 248 engagable with the bottle 211, with a hole 262 through which the fluid enters the lower cavity 214, an end cap 219 engaged inside the housing 248 and accommodating the refill mechanism 240, the refill mechanism including a first sealing ring 244, a positioning ring 249, a hollow piston 242, and a second seal ring 263. A holed bottom cover inner shell 217 (absent in the embodiment 100 in FIG. 1) snaps on housing 248. A holed bottom cover outer shell 218 engages the bottle 211 to create an aesthetic continuity of the shape of the bottle 211.

The positioning ring 249 helps keep the piston 242 in a correct position in the refill chamber 260.

The dispensing mechanism 230 includes the tube 204, a pump 232, a collar fitting 234 that helps the pump 232 engage the bottle 211, a decorative outer collar 236 that snugly fits over the collar fitting 234, and an actuator 238 that is plugged onto the pump 232. A top cover 203 covers the actuator 238. As explained above, the pump 232 of the dispensing mechanism is preferably compact and minimally extends into the upper cavity 112, as is shown in FIG. 2b.

When the dispenser is used for different fluids of widely varying viscosities, or for varying amounts of dispensed fluid, the easiest way to adjust the dispensation is by replacing the actuator 238. According to one aspect of the invention a set of actuators 238 are provided, each with a nozzle 239 of different size. Alternatively or additionally, a larger pump may be used to dispense larger amounts; however it is generally more difficult and expensive to replace the pump.

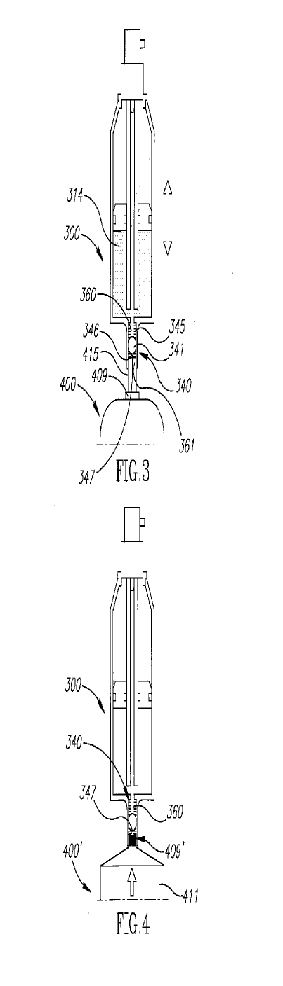

FIGS. 3 and 4 schematically illustrate filling of a refillable dispenser 300 by non-refillable dispensers 400, 400′. The dispensing mechanism 409 of the dispenser 400 shown in FIG. 3 is actuated by a pumping action, whereas the dispensing mechanism 409′ of the dispenser 400′ shown in FIG. 4 is actuated by pressing the refillable dispenser 300 and the non-refillable dispenser 400′ toward each other. Bottle 411 containing the viscous composition may be pressurized.

In some embodiments the refill mechanism comprises a check-valve. In some embodiments, the dispensing mechanism comprises a check valve (to help prevent entrance of air into the lower cavity via the valve).

In some embodiments, both the refill mechanism and the dispensing mechanism each comprise a check-valve.

The refill mechanism in the embodiment 300 shown in FIGS. 3 and 4 comprises a bead 341 and a spring 345 urging the bead 341 toward the opening 361 of the refill chamber 360. When the stem 415 of the non-refillable dispenser 400 is pushed against a ledge 346 in the chamber 360, the ledge having a hole 347, fluid from the non-refillable dispenser 400 pushes the bead 341 towards the lower cavity 314. The chamber 360 may have grooves in its walls (not shown), or the bead may have grooves (not shown), for example, to allow the fluid to bypass the bead into the lower cavity.

Other refill mechanisms may be used that allow fluid to enter into the refillable dispenser by a stem directly pushing the refill mechanism, or by a fluid pushing the refill mechanism.

The non-refillable dispenser 400 shown in FIG. 3 is actuated to deliver the fluid stored therein by pumping the stem of 415 non-refillable dispenser 400 against the refillable bottle 311 as shown, whereas the non-refillable dispenser 400′ in depicted in FIG. 4 is a syringe type dispenser that allows to manually inject the fluid into the refill mechanism 340.

The upper cavity 212 comprises a roof 205. In this dispenser embodiment 200 continuous refilling of the dispenser eventually allows the gasket 220 to contact the roof 205, thus allowing full utilization of the bottle 210 both in filling and in emptying.

Commercially available dispensers can perhaps be refilled by removing their dispensing mechanism, but for all practical purposes such refilling is time consuming and difficult, and thus they are essentially non-refillable. Furthermore, their size, typically 250 mL or larger, is substantially larger than the refillable dispensers, which are typically less than 100 mL size, so that there is little motivation to refill the larger dispensers.

Many commercially available dispensers have a dispensing head (not shown) that may be removed in order to expose the dispensing mechanism 409 of the non-refillable dispenser 400, the exposed mechanism 409 may then be easily coupleable to the refill mechanism. Such removal will typically expose a structure such as a stem 415 of the dispensing mechanism 409 (see FIG. 3). Many commercially available dispensers have a screw-top.

According to another aspect, a kit comprising any refillable dispenser of the types described above, and at least one adapter is provided, the adapters each configured to allow sealingly and fluidly connecting a non-refillable dispenser for viscous compositions with the filling mechanism of the refillable dispenser. Each adapter is suitable for a particular structure of dispensing mechanism of the non-refillable dispenser. Thus, a set of adapters may serve to couple the first refillable dispenser with various commercially available non-refillable dispensers.

The adapter may comprise a tube having ends with the same or different sizes. Typically, one end tightly fits into the refill mechanism of the refillable dispenser, and the other end tightly fits onto a stem of the dispensing mechanism of the non-refillable dispenser to make a sealed connection for transfer of the viscous composition from the non-refillable dispenser to the refillable one. Alternatively, the adapter may be a dispensing mechanism itself that replaces the original dispensing mechanism of the non-refillable dispenser. For example, the dispensation mechanism of these non-refillable dispensers may be removed and another dispensation mechanism of appropriate structure may be screwed on to the screw top for communication of the non-refillable dispenser with the refillable dispenser. Such mechanism may include for example a pump (not shown) and a stem 415 that closely fits inside an opening 261 in the refill chamber 260.

In other embodiments the non-refillable dispenser is simply a receptacle without any dispensing mechanism at all, for example a jar for cream with a thread at the top and a lid with a matching thread, and the adapter is then coupled to the jar without the lid. However, in such embodiments the force to refill must be provided by the refill mechanism of the refill dispenser. In preferred embodiments the non-refillable dispenser comprises a manual dispensation pump fluidly connectable to the refillable dispenser, and the refillable dispenser can be filled by repeatedly pressing the pump. The repeated pressing allows to dispense small amounts of fluid from the dispensing mechanism of the non-refillable dispenser with moderate force, thereby helping to prevent overfilling and damage to the small refill mechanism of the refill dispenser.

In preferred embodiments, the refill mechanism of the refillable bottle further comprises at least one second sealing ring, as shown in FIGS. 1 and 2, ring 163 in the refill chamber 160 below a check valve (in FIGS. 1 and 2 comprising a piston 142 and compression spring 145) to provide a sealed connection.

According to another aspect, a kit comprising the refillable dispenser and a non-refillable dispenser is provided. The uniqueness of the non-refillable dispenser in this embodiment is that the refillable dispenser and the non-refillable dispenser are configured to allow sealingly connecting the non-refillable dispenser with the refill mechanism, preferably without need for an adapter. Such non-refillable dispenser may be a commercially available dispenser, the refillable dispenser being specially fitted in the dimensions of the refill mechanism to the dispensing mechanism of the non-refillable dispenser, but perhaps more typically the non-refillable dispenser is also specially designed to easily and tightly fit with the refillable dispenser.

Typically, the non-refillable dispenser will be economy-sized and too large to carry in a wallet, pocket etc. The non-refillable dispenser further minimizes waste of material.

It is notable that while the non-refillable refillable dispenser is ideal to use at home, the refillable dispenser is ideal for use on airplanes, since at present only very small containers of viscous compositions are allowed to be airborne in a flight cabin.

Some embodiments may be manipulated to have a sub-pressure in the lower cavity, at least when the lower cavity is essentially empty of material and ready to receive more material. This may be accomplished by having a gasket that cannot travel all the way down to the bottom of the lower cavity, thus a space may be left after dispensing is finished, in which a sub-pressure may be created.

According to one embodiment, the dispensing method may, prior to the initial filling of the lower cavity with product, provide for the mounting of a take-off device on the bottle in a storage position in which the air tightness of the lower cavity is reinforced, said take-off device subsequently being moved into a dispensing position. This is because, in the dispensing position, the static air tightness of the lower cavity having a negative pressure may be insufficient, in particular in the presence of a vent hole, to guarantee the maintenance of this negative pressure at the end of prolonged storage.

In addition, still in order to improve the maintenance of the negative pressure over time, the refill mechanism may be reversibly covered with a sealing cap (not shown). The cap may be welded in a recess formed on the free end of a trim (not shown) so that said cap completely covers the refill mechanism, said cap having a free edge enabling it to be withdrawn with a view to the initial filling.

The sub-pressure may facilitate refilling the dispenser. Such embodiments are more useful when the material is not overly viscous, such as various lotions. Shaking the lotion (thereby sometimes reducing the viscosity) just prior to refilling may facilitate the refilling in such cases.

Some creams and lotions and colloids may undergo sedimentation, flocculation etc, such that the separation of solids is both undesirable as a product to be applied, and may in some embodiments interfere with the operation of the dispenser, in which case it may be advantageous to shake the dispenser shortly before dispensing. In such cases excessive shaking may be ill-advised, as the shaking may overly reduce the viscosity of the viscous material. Some experimentation may be required to produce the most desirable results, both in respect of the quality of the material, and in respect of the more satisfactory operation of the dispenser. Some embodiments may be more suitable for particular types of viscous materials.

The examples described above present various selected embodiments of a refillable cream dispenser . It is noted that further embodiments are anticipated which also fall within the scope of the present invention. The scope of the present invention is defined by the claims and includes both combinations and sub combinations of the various features described hereinabove as well as variations and modifications thereof, which would occur to persons skilled in the art upon reading the foregoing description.

1. A dispenser comprising:
a bottle having an external wall;
a gasket within the bottle, the gasket defining within the bottle an upper cavity and a lower cavity and configured to substantially seal said upper cavity from said lower cavity;
a fluid dispensing mechanism configured to allow fluid to be dispensed from said lower cavity to outside the bottle when the dispensing mechanism is actuated;
wherein said gasket is capable of moving towards the lower cavity upon actuation of the dispensing mechanism and of moving towards the upper cavity resultant upon entrance of the fluid into said lower cavity; and
a fluid refill mechanism configured to allow fluid to enter said lower cavity when said refill mechanism is fluidly coupled to a fluid source.

2. The refillable dispenser of claim 1, wherein the dispensing mechanism extends throughout the gasket to the lower cavity.

3. The refillable dispenser of claim 2, wherein the dispensing mechanism comprises a tube extending into the lower cavity.

4. The refillable dispenser of claim 3, wherein the lower cavity comprises a floor through which the fluid can enter the lower cavity, and wherein the tube extends to less than 0.5 mm from the floor.

5. The refillable dispenser of claim 4, wherein the tube extends to 0.2-0.3 mm from the floor.

6. The refillable dispenser of claim 1, wherein the refill mechanism comprises a check-valve.

7. The refillable dispenser of claim 6, further comprising a refill chamber containing the refill mechanism, wherein the dispenser is configured to allow the refill chamber to be in fluid communication with the lower cavity, and allow the refill mechanism to remain essentially entirely inside the refill chamber, when the refill mechanism is actuated.

8. The refillable dispenser of claim 1, wherein the upper cavity comprises a roof, and wherein actuation of the dispensing mechanism allows the gasket to contact the roof.

9. The dispenser of claim 3, wherein the gasket is sealingly sleeved on the tube and in the bottle.

10. The refillable dispenser of claim 1, wherein the refill mechanism has a seat that is movable, and/or deformable, or movable and deformable between a stable state of sealed closure of the lower cavity and a stressed state of putting a non-refillable dispenser in communication with said lower cavity.

11. The dispenser of claim 1, further comprising a vent hole that is arranged to compensate for dispensed fluid with air.

12. The dispenser of claim 11, wherein the vent hole extends from the upper cavity to outside the bottle.

13. The dispenser of claim 11, wherein the vent hole comprises a gap between the dispensing mechanism and the bottle.

14. A kit comprising the refillable dispenser of claim 1 and at least one adapter, each at least one adapter being configured to allow sealingly and fluidly coupling a non-refillable dispenser with the refill mechanism of the refillable dispenser.

15. A kit comprising the refillable dispenser of claim 1 and a non-refillable dispenser for viscous compositions, the refillable dispenser and the non-refillable dispenser sealingly and fluidly connectable thereto.

16. The kit of claim 14, wherein the non-refillable dispenser comprises a manual dispensation pump fluidly connectable to the refillable dispenser and wherein the refillable dispenser can be filled by repeatedly pressing the pump.

17. The kit of claim 15, wherein the non-refillable dispenser comprises a manual dispensation pump fluidly connectable to the refillable dispenser and wherein the refillable dispenser can be filled by repeatedly pressing the pump.

18. The kit of claim 14, wherein the non-refillable dispenser is substantially larger than the refillable dispenser.

19. The kit of claim 15, wherein the non-refillable dispenser is substantially larger than the refillable dispenser.
